(19) United States
(12) Patent Application Publication
(10) Pub. No.: US 2014/0289144 A1
(43) Pub. Date: Sep. 25, 2014

(54) SYSTEMS, METHODS, AND DEVICES FOR MATCHING A JOB OPENING AND/OR JOB CANDIDATE WITH A JOB TYPE

(71) Applicant: Futures Inc., Durham, NC (US)

(72) Inventors: W. Scott Coleman, Scottsdale, AZ (US); George Geoffrey Cramer, Raleigh, NC (US)

(73) Assignee: Futures Inc., Durham, NC (US)

(21) Appl. No.: 14/218,779

(22) Filed: Mar. 18, 2014

Related U.S. Application Data
(60) Provisional application No. 61/803,249, filed on Mar. 19, 2013.

(51) Int. Cl. G06Q 10/10

(52) U.S. Cl. CPC G06Q 10/1053
USPC 705/321

(57) ABSTRACT

Methods for matching a job opening and/or a job candidate with a job type are provided. A method of matching a job opening with a job type may include receiving job opening information via an electronic device and/or a server, and matching a plurality of job openings described in the job opening information with a plurality of respective job types, using an electronic database. A method of matching a job candidate with a job type may include identifying one or more job skills and/or job credentials of the job candidate, and matching the job candidate with one or more predetermined job types by matching the one or more job skills and/or job credentials of the job candidate with one or more skills and/or credentials corresponding to the one or more predetermined job types, using an electronic database.

### CLAIM OF PRIORITY

The present application claims the benefit of U.S. Provisional Patent Application Ser. No. 61/803,249, filed Mar. 19, 2013, entitled Systems, Methods, and Devices for Matching a Job Opening and/or Job Candidate with a Job Type, the disclosure of which is hereby incorporated herein in its entirety by reference.

### FIELD

The present disclosure relates to systems, methods, and devices using job opening information and/or job candidate information.

### BACKGROUND

Many job searching techniques are inefficient for job candidates. Similarly, many job candidate searching techniques are inefficient for employers. For example, although numerous job openings and numerous job candidates may be available, obtaining a good match between a job opening and a job candidate may be challenging and/or time-intensive because it may be difficult for an employer to identify whether a particular job candidate is a good match for a particular job opening, and it may be difficult for the particular job candidate to identify whether he/she is a good match for the particular job.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the present inventive concepts.

Various embodiments of the present inventive concepts include a method of matching a job opening with a job type. The method may include receiving job opening information via an electronic device and/or a server, and matching a plurality of job openings described in the job opening information with a plurality of respective job types, using an electronic database.

In various embodiments, the plurality of job types may include a plurality of predetermined job types, respectively. Moreover, the plurality of predetermined job types may correspond to a plurality of unique identifiers, respectively. In some embodiments, the method may include assigning the unique identifiers to the plurality of job types, before receiving the job opening information. Additionally or alternatively, in some embodiments, the unique identifiers may distinguish different ones of the plurality of predetermined job types and may be linked with aliases, descriptors, titles, and/or other information corresponding to the plurality of predetermined job types.

According to various embodiments, the electronic database may include an electronic database of job title aliases, and matching the plurality of job openings described in the job opening information with the plurality of respective job types may include matching the plurality of job openings described in the job opening information with the plurality of respective job types, using the electronic database of job title aliases. Moreover, the plurality of job types may be mapped to a plurality of respective job skills and/or job credentials in the electronic database.

A method of matching a job candidate with a job type, according to various embodiments, may include identifying one or more job skills and/or job credentials of the job candidate. Moreover, the method may include matching the job candidate with one or more predetermined job types by matching the one or more job skills and/or job credentials of the job candidate with one or more skills and/or credentials corresponding to the one or more predetermined job types, using an electronic database. In some embodiments, the electronic database may include a military-to-civilian electronic database that matches military skills, codes, and/or credentials with civilian job skills and/or civilian job credentials, and matching the one or more job skills and/or job credentials of the job candidate with the one or more skills and/or credentials corresponding to the one or more predetermined job types may include matching one or more military skills, codes, and/or credentials of the job candidate with the one or more civilian job skills and/or civilian job credentials corresponding to the one or more predetermined job types, using the military-to-civilian electronic database.

In various embodiments, the method of matching the job candidate with the job type may include matching the job candidate with one or more job openings, using the one or more predetermined job types that are matched with the job candidate. In some embodiments, the one or more job skills and/or job credentials of the job candidate may include an indication of years of experience of the job candidate, and matching the one or more job skills and/or job credentials of the job candidate with the one or more skills and/or credentials corresponding to the one or more predetermined job types may include matching the one or more job skills and/or job credentials of the job candidate with the one or more skills and/or credentials corresponding to the one or more predetermined job types, using the indication of years of experience of the job candidate.

According to various embodiments, matching the job candidate may include matching the job candidate with one or more careers and/or with the one or more predetermined job types, by matching the one or more job skills and/or job credentials of the job candidate with one or more skills and/or credentials corresponding to the one or more careers and/or with the one or more skills and/or credentials corresponding to the one or more predetermined job types, using the electronic database.

A method of creating a customized job type for an employer, according to various embodiments, may include receiving job opening information via an electronic device and/or a server, and creating an employer-specific customized job type for a job opening described in the job opening information, using an electronic database. Moreover, the employer-specific customized job type may correspond to one or more unique identifiers. In some embodiments, creating the employer-specific customized job type may include assigning the one or more unique identifiers to the employer-specific customized job type. In some embodiments, each of the one or more unique identifiers distinguishes the employer-specific customized job type from other job types.

In various embodiments, creating the employer-specific customized job type may include mapping the employer-specific customized job type to one or more job skills and/or job credentials in the electronic database. The one or more job skills and/or job credentials may include an indication of years of experience preferred or required by the employer. Moreover, the one or more job skills and/or job credentials may include one or more certifications and/or levels of education preferred or required by the employer. In some embodiments, each of the one or more job skills and/or job credentials may include an indication of a relative importance to the employer.

According to various embodiments, the method of creating the customized job type for the employer may include analyzing the job opening information to identify the one or more job skills and/or job credentials, before mapping the employer-specific customized job type to the one or more job skills and/or job credentials in the electronic database, where creating the employer-specific customized job type for the job opening may include creating the employer-specific customized job type using the one or more job skills and/or job credentials identified in the job opening information. The method may include comparing the one or more job skills and/or job credentials identified in the job opening information with one or more job skills and/or job credentials of one or more job candidates. Moreover, the method may include storing an employer-specific identifier corresponding to at least one of the one or more job candidates exceeding a threshold match with the one or more job skills and/or job credentials identified in the job opening information.

In various embodiments, the method of creating the customized job type for the employer may include indicating a job skills and/or job credentials threshold to at least one of the one or more job candidates failing to meet a threshold match with the one or more job skills and/or job credentials identified in the job opening information. The electronic database may include a military-to-civilian electronic database that matches military skills, codes, and/or credentials with civilian job skills and/or civilian job credentials, and comparing the one or more job skills and/or job credentials identified in the job opening information with the one or more job skills and/or job credentials of the one or more job candidates may include comparing one or more military skills, codes, and/or credentials of the one or more job candidates with the one or more civilian job skills and/or civilian job credentials corresponding to the employer-specific customized job type, using the military-to-civilian electronic database.

A method of displaying job candidates based on job type, according to various embodiments, may include accessing an electronic database including a plurality of job candidates, filtering the plurality of job candidates according to one or more predetermined job types, and displaying ones of the plurality of job candidates remaining after the filtering, according to geographic location and/or geographic preference. The one or more predetermined job types may be mapped to one or more job skills and/or job credentials in the electronic database.

A method of displaying job candidates based on job type, according to various embodiments, may include accessing an electronic database including a plurality of job candidates, filtering the plurality of job candidates according to one or more employer-specific customized job types, and displaying ones of the plurality of job candidates remaining after the filtering, according to geographic location. The one or more employer-specific customized job types may be mapped to one or more job skills and/or job credentials in the electronic database.

A method of displaying job openings based on job type, according to various embodiments, may include accessing an electronic database including a plurality of job openings, filtering the plurality of job openings according to one or more predetermined job types, and displaying ones of the plurality of job openings remaining after the filtering, according to geographic location. The one or more predetermined job types may be mapped to one or more job skills and/or job credentials in the electronic database.

A method of displaying job openings based on job type, according to various embodiments, may include accessing an electronic database including a plurality of job openings, filtering the plurality of job openings according to one or more employer-specific customized job types, and displaying ones of the plurality of job openings remaining after the filtering, according to geographic location. The one or more employer-specific customized job types may be mapped to one or more job skills and/or job credentials in the electronic database.

A method of visually comparing job candidates, according to various embodiments, may include accessing an electronic database of job candidates, filtering the job candidates according to one or more predetermined job types, selecting for comparison a plurality of the job candidates remaining after the filtering, and displaying a visual comparison of ones of the plurality of job candidates that are selected for comparison. Displaying the visual comparison may include displaying a visual comparison of job skills, certifications, salary expectations, current geographic locations, and/or education levels of the ones of the plurality of job candidates, with respect to a job opening. In some embodiments, displaying the visual comparison may include displaying a radar chart comparison that uses partially-overlapping polygons to compare the job skills, certifications, salary expectations, current geographic locations, and/or education levels of the ones of the plurality of job candidates. In some embodiments, displaying the visual comparison may include displaying an indication of one or more scholarships that are available to train one or more of the ones of the plurality of job candidates.

In various embodiments, displaying the visual comparison may include displaying an impact, with respect to the visual comparison, of accepting the one or more scholarships. In some embodiments, the method of visually comparing job candidates may include transmitting an interview offer or a job offer to one or more of the ones of the plurality of job candidates.

A method of employment support for a job candidate, according to various embodiments, may include creating an electronic job candidate profile for the job candidate, receiving an electronic assessment of job skills and/or job credentials of the job candidate, where the job skills and/or job credentials are mapped to one or more predetermined job types in an electronic database, and receiving one or more electronic matches of the job candidate with one or more job openings, using the one or more predetermined job types. Moreover, the method may include receiving electronic information regarding job opportunities, after receiving the electronic assessment, and receiving electronic information regarding educational, training, and/or certification opportunities, after receiving the electronic information regarding job opportunities.

In various embodiments, receiving the electronic information regarding job opportunities may include receiving an indication of a job skills and/or job credentials threshold that the job candidate fails to meet. Moreover, receiving the electronic information regarding educational, training, and/or certification opportunities may include receiving information regarding educational, training, and/or certification opportunities that will help the job candidate to meet the job skills and/or job credentials threshold.

According to various embodiments, creating the electronic job candidate profile may include electronically importing a military individual transition plan of the job candidate. Moreover, receiving the electronic assessment may include receiving one or more matches between civilian careers and one or more Military Occupational Specialty (MOS) codes of the job candidate.

It is noted that aspects of the present inventive concepts described with respect to one embodiment may be incorporated in a different embodiment although not specifically described relative thereto. That is, all embodiments and/or features of any embodiment can be combined in any way and/or combination. Applicants reserve the right to change any originally filed claim or file any new claim accordingly, including the right to be able to amend any originally filed claim to depend from and/or incorporate any feature of any other claim although not originally claimed in that manner. These and other objects and/or aspects of the present inventive concepts are explained in detail below.

### BRIEF DESCRIPTION OF THE DRAWINGS

The accompanying drawings, which form a part of the specification, illustrate various embodiments of the present inventive concepts. The drawings and description together serve to fully explain embodiments of the present inventive concepts.

FIGS. 1A-1C are flowcharts illustrating operations of matching a job opening with a job type, according to various embodiments of the inventive concepts.

FIGS. 2A-2C are flowcharts illustrating operations of matching a job candidate with a job type, according to various embodiments of the inventive concepts.

FIGS. 3A-3E are flowcharts illustrating operations using customized job types that are specific to respective employers' needs, according to various embodiments of the inventive concepts.

FIGS. 4A-4D are flowcharts illustrating operations of displaying job candidates and job openings based on job type, according to various embodiments of the inventive concepts.

FIGS. 5A-5F are flowcharts illustrating operations of visually comparing job candidates, according to various embodiments of the inventive concepts.

FIGS. 6A-6C are flowcharts illustrating operations of electronic employment support for a job candidate, according to various embodiments of the inventive concepts.

FIGS. 7A-7K are screenshots of an electronic device performing various operations illustrated in the flowcharts of FIGS. 5A-5F.

FIG. 8 illustrates an employment support process flow for a soldier/retired soldier.

FIG. 9 is a block diagram that illustrates details of an example processor and memory that may be used in accordance with various embodiments of the inventive concepts.

### DETAILED DESCRIPTION

Example embodiments of the inventive concepts now will be described with reference to the accompanying drawings. The inventive concepts may, however, be embodied in a variety of different forms and should not be construed as limited to the embodiments set forth herein. Rather, these embodiments are provided so that this disclosure will be thorough and complete, and will fully convey the scope of the inventive concepts to those skilled in the art. In the drawings, like designations refer to like elements. It will be understood that when an element is referred to as being “connected,” “coupled,” or “responsive” to another element, it can be directly connected, coupled or responsive to the other element or intervening elements may be present. Furthermore, “connected,” “coupled,” or “responsive” as used herein may include wirelessly connected, coupled or responsive.

The terminology used herein is for the purpose of describing particular embodiments only and is not intended to be limiting of the inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will also be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the inventive concepts.

Although many job searching techniques and job candidate searching techniques are inefficient, various embodiments of the inventive concepts may provide for faster and/or more precise matches between job openings and job candidates. For example, various embodiments of the inventive concepts may use discrete job types to improve matches between job openings and job candidates. Examples of discrete job types include plumber, machinist, and electrician, among various others. Moreover, it will be understood that the term “job type,” as used herein, may refer to a discrete, standardized, and/or a specific identification/code. The identification/code may correspond to a particular career and/or job opening. Each job type may correspond to one or more discrete skills/credentials, such as the ability to drive a forklift, management skills, a given certification, and the like. Such discrete skills/credentials may also be identified for each job candidate. Accordingly, faster and/or more precise matches between job openings and job candidates may be provided by matching a particular job opening and/or a particular job candidate with a job type. Moreover, the operations described herein may reduce underemployment by identifying gaps in skills, training, and/or certifications that may otherwise hinder better employment.

A. Matching a Job Opening with a Job Type

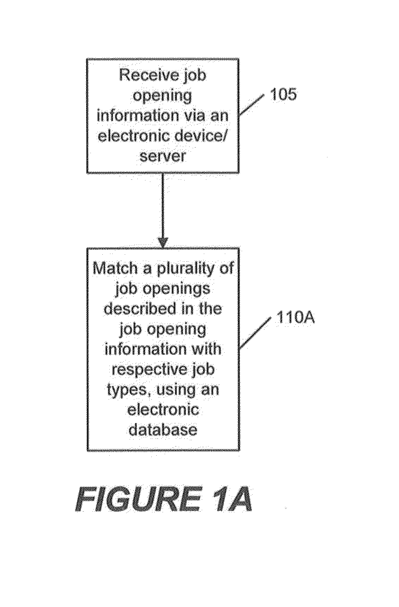

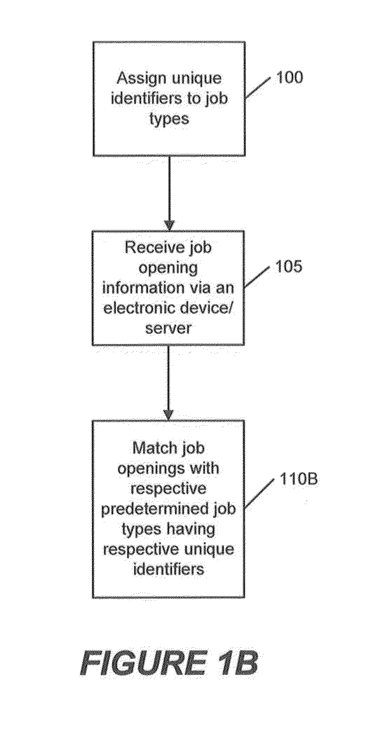

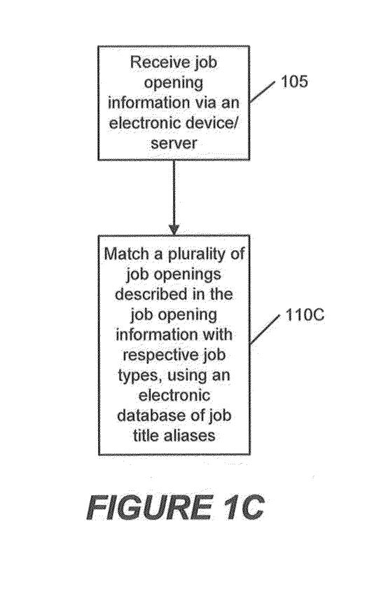

Referring now to FIGS. 1A-1C, flowcharts are provided illustrating operations of matching a job opening with a job type, according to various embodiments of the inventive concepts. Referring to FIG. 1A, the operations may include receiving job opening information (Block 105). The job opening information may be received via a server or group/system of servers and/or an electronic device, such as a computer (e.g., tablet, laptop, or desktop computer) or a mobile phone. The job opening information may be obtained from one or more employers and/or from a third party. The job opening information may include unstructured information, such as descriptions and/or titles of respective job openings. The job opening information may additionally or alternatively include standardized, occupation-specific descriptors/codes and/or names of industry groups.

An electronic database may match a plurality of job openings described in the job opening information received in Block 105 with respective job types (Block 110A). The electronic database may be stored in and/or accessed by the server(s)/electronic device receiving the job opening information. The electronic database may include, or may access, a database of aliases for job types, which may include a plurality of titles/descriptors corresponding to a plurality of job types. For example, different employers may use different job titles/aliases for a particular job type. Accordingly, the database of aliases may map the aliases to job types. Moreover, it will be understood that the term “database,” as used herein, may refer to an individual database or a plurality of databases. As such, when different types of data/information are described herein as being in a database, the different types of data/information may be in the same database or may be in separate databases that are used to perform the operations described herein.

Referring to FIG. 1B, job types described herein may be predetermined job types having respective unique identifiers (Block 110B). In other words, the predetermined job types may have been assigned the unique identifiers before receipt of the job opening information in Block 105 (Block 100). The unique identifiers of the predetermined job types may be used to distinguish different predetermined job types and may link to aliases, descriptors/titles, and/or other information corresponding to particular job types.

Referring to FIG. 1C, operations of matching a plurality of job openings described in the job opening information received in Block 105 with respective job types may be performed using an electronic database of job title aliases (Block 110C). For example, matching the job openings with job types may include comparing aliases in the job opening information with aliases in the electronic database of job title aliases.

B. Matching a Job Candidate with a Job Type

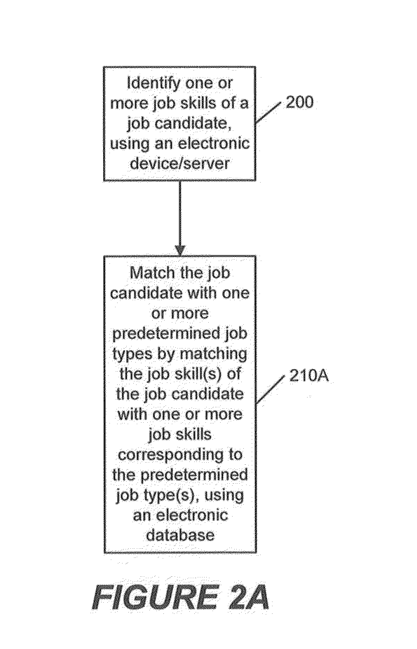

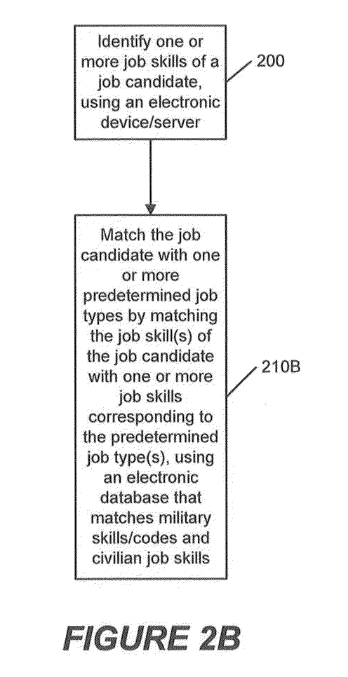

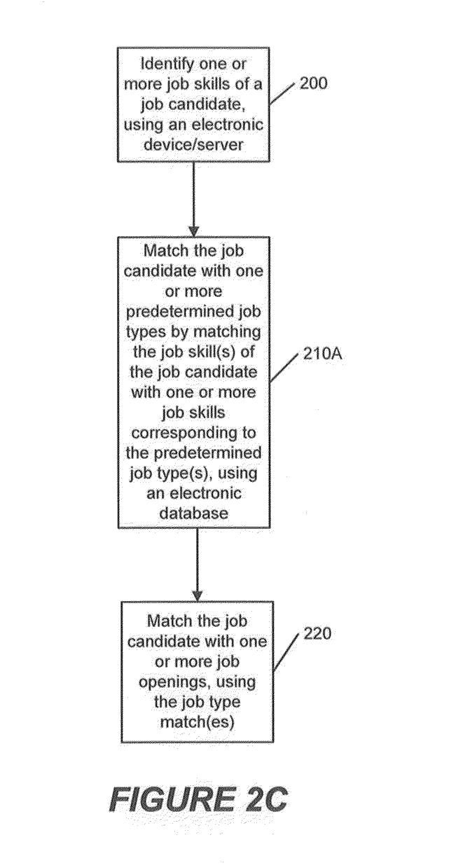

Referring now to FIGS. 2A-2C, flowcharts are provided illustrating operations of matching a job candidate with a job type, according to various embodiments of the inventive concepts. Referring to FIG. 2A, the operations may include identifying one or more skills (e.g., job skills) of a particular job candidate (Block 200). Before identifying the skill(s), job candidate information may be received via a server or group/system of servers and/or an electronic device, such as a computer (e.g., tablet, laptop, or desktop computer) or a mobile phone. The job candidate information may be obtained from the job candidate and/or from a third party. Accordingly, identifying the skill(s) may include identifying the skill(s) by using job candidate information that is electronically received from the job candidate and/or from a third party.

The server(s) and/or the electronic device may then use an electronic database to match the job candidate with one or more predetermined job types (and/or one or more careers), by matching the identified skill(s) of the job candidate with one or more job skills corresponding to the predetermined job type(s) (and/or the career(s)) (Block 210A). The electronic database may be stored in and/or accessed by the server(s)/electronic device identifying the job skill(s). The electronic database may include, or may access, a database including discrete job skills that are mapped to predetermined job types.

Moreover, a match with a predetermined job type may require exceeding a threshold score/rank with respect to how closely the identified skill(s) of the job candidate match the job skill(s) that correspond to the predetermined job type(s). Accordingly, the operations in Block 210A may further include scoring/ranking how closely the identified skill(s) of the job candidate match the job skill(s) that correspond to the predetermined job type(s), and determining whether the score(s)/rank(s) exceed a threshold score/rank.

Additionally or alternatively, the identified skill(s) of the job candidate may include an indication of the job candidate's years of experience for the identified skill(s). Accordingly, the operations in Block 210A may further include using the job candidate's years of experience to match his/her job skill(s) with the skill(s) that correspond to the predetermined job type(s). As an example, a match with a given predetermined job type may require a threshold number of years of experience. As another example, a match with a given predetermined job type may be scored/ranked higher or lower depending on whether the job candidate's years of experience are relatively high or relatively low, respectively.

Referring to FIG. 2B, a job candidate may have military experience. Accordingly, an electronic database may include, or may access, an electronic database that matches military skills/codes (e.g., Military Occupational Specialty (MOS) codes) with discrete civilian job skills. For example, thousands, or more, of military skills/codes may be mapped to civilian job skills in the electronic database. Matching a job candidate with one or more predetermined job types may thus include matching one or more military skills/codes of the job candidate with one or more civilian job skills (Block 210B).

Referring to FIG. 2C, the operations illustrated in FIG. 2A may further include electronically matching (e.g., using the server(s) and/or the electronic device) the job candidate with one or more job openings, using one or more job type matches provided in Block 210A (Block 220). For example, if the job candidate is matched with a machinist job type, then the job candidate may be further matched with one or more job openings that have also been matched with the machinist job type. Moreover, one or more unique identifiers corresponding to the matched predetermined job type(s) may be stored in a profile of the job candidate before matching the job candidate with one or more job openings in Block 220, such that the matching in Block 220 may be performed at any time in the future.

Although FIGS. 2A-2C indicate job skills, it will be understood that discrete job skills and/or discrete credentials may be identified/matched using the operations of FIGS. 2A-2C. For example, for a job candidate having both forklift operator skills and a forklift operator certification, the skills and/or the certification may be identified/matched using the operations of FIGS. 2A-2C,

C. Customized Job Types

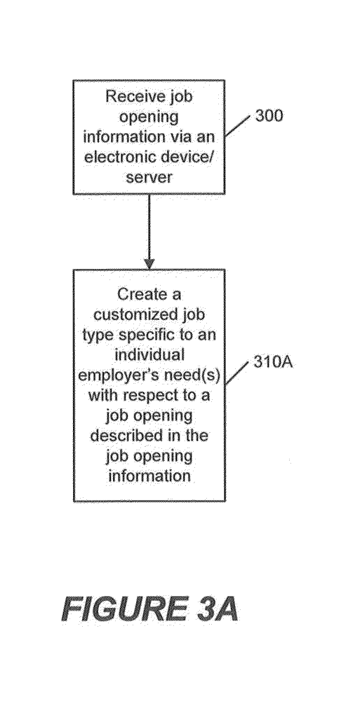

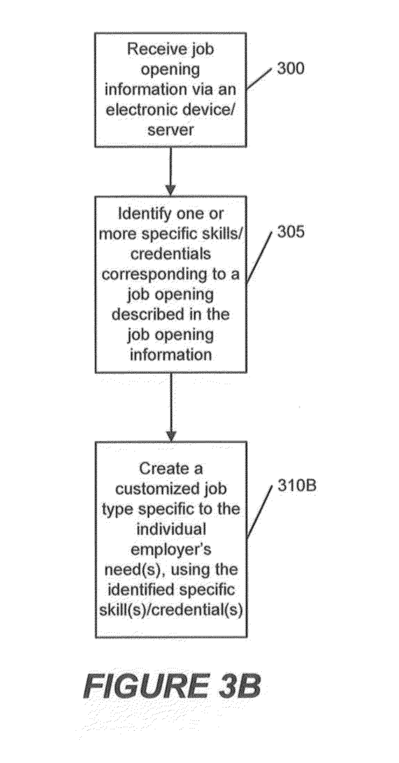

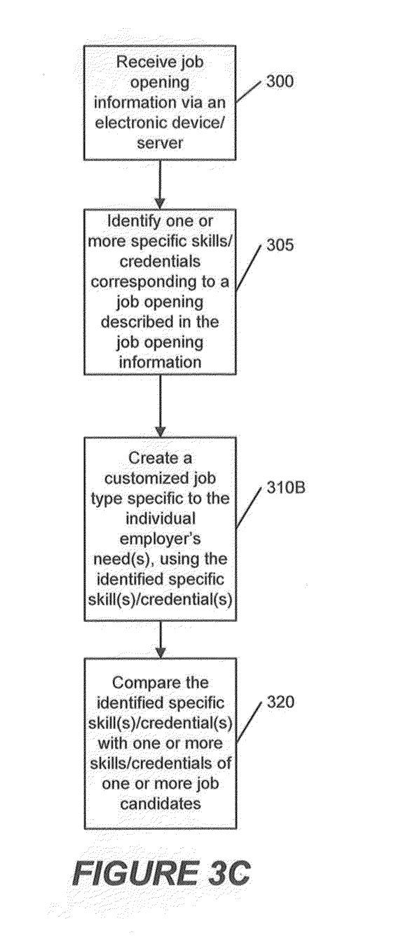

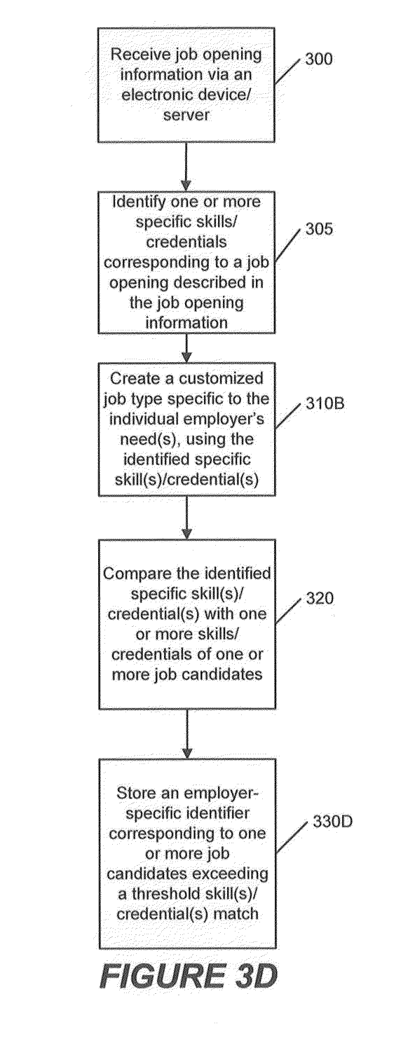

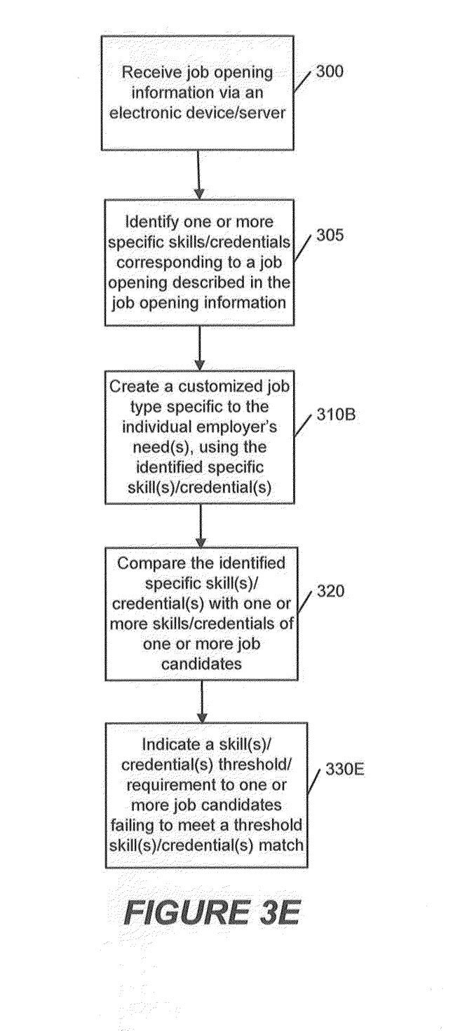

Although a discrete, standardized job type may be used with respect to job openings of various different employers, a particular employer may sometimes have a particular job opening for which the employer wants to obtain an even more precise match with job candidate skills/credentials. For example, an employer that hires machinists may need specialized machinists that can operate the employer's particular equipment. Accordingly, referring now to FIGS. 3A-3E, flowcharts are provided illustrating operations using customized job types that are specific to respective employers' needs, according to various embodiments of the inventive concepts.

Referring to FIG. 3A, the operations may include receiving job opening information (Block 300). The job opening information may be received via a server or group/system of servers and/or an electronic device, such as a computer (e.g., tablet, laptop, or desktop computer) or a mobile phone, from a particular employer and/or a third party authorized by the particular employer. Next, an electronic database may be used to create an employer-specific customized job type for a job opening described in the job opening information (Block 310A). Moreover, it will be understood that the operations in FIGS. 3A-3E may be performed by corporate recruiters, staffing firm recruiters, and/or administrators of the electronic database, using the electronic device/server(s).

Referring to FIG. 3B, the electronic device/server(s) may analyze the job opening information received in Block 300 to identify job skill(s) and/or job credential(s) (Block 305). Moreover, creating the employer-specific customized job type for the job opening may include creating the employer-specific customized job type using the job skill(s) and/or job credential(s) identified in the job opening information (Block 310B). For example, creating the employer-specific customized job type may include mapping the employer-specific customized job type to job skill(s) and/or job credential(s) in the electronic database. Moreover, the job skill(s) may include an indication of years of experience preferred or required by the employer. Additionally or alternatively, the job skill(s) and/or job credential(s) in the electronic database may include one or more certifications and/or levels of education preferred or required by the employer. Furthermore, the skill(s) and/or job credential(s) in the electronic database may each correspond to an indication of relative importance to the employer, as the employer may consider some skill(s) and/or job credential(s) more important than others.

An employer-specific customized job type may correspond to one or more unique identifiers. For example, the operations in Block 310A of creating the employer-specific customized job type may include assigning one or more unique identifiers to the employer-specific customized job type. A unique identifier may distinguish the employer-specific customized job type from other job types.

Referring now to FIG. 3C, after creating the employer-specific customized job type in Block 310B, an electronic database may be used to compare the job skill(s) and/or job credential(s) identified in the job opening information with one or more job skills and/or job credentials of one or more job candidates (Block 320). For example, the electronic database may include, or have access to, data including the job skill(s) and/or job credential(s) of the job candidate(s). Referring to FIG. 3D, the electronic database may include a database that stores an employer-specific identifier corresponding to any job candidate(s) exceeding a threshold match with the job skill(s) and/or job credential(s) identified in the job opening information (Block 330D). The stored employer-specific identifier may be used to indicate the successful match to the employer and/or the job candidate(s).

Additionally or alternatively, referring to FIG. 3E, if one or more job candidates fail to meet a job skill(s) and/or job credential(s) threshold, then an indication may be provided (e.g., transmitted electronically) to the job candidate(s) failing to meet the threshold (Block 330E). For example, the indication may identify an education level and/or a certification required by the employer for the particular job. Accordingly, the inventive concepts may help job candidates lacking education/certification to know specifically what they need to qualify for the particular job.

Moreover, as discussed above regarding FIG. 2B, it will be understood that a job candidate may have military experience. Accordingly, the skill(s)/certification(s) comparison in Block 320 of FIGS. 3C-3E may include comparing one or more military skills, codes, and/or credentials of the job candidate(s) with one or more civilian job skills and/or civilian job credentials corresponding to the employer-specific customized job type. For example, the electronic database may include, or may access, a military-to-civilian electronic database that matches military skills/codes (e.g., MOS codes) with discrete civilian job skills.

D. Display/Visualization of Job Openings and Job Candidates

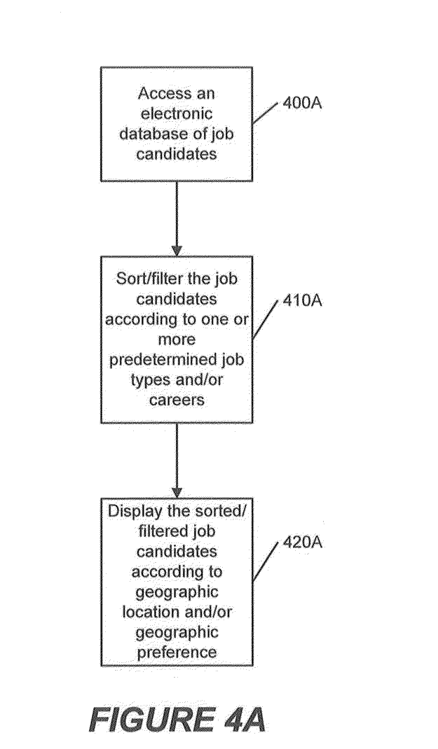

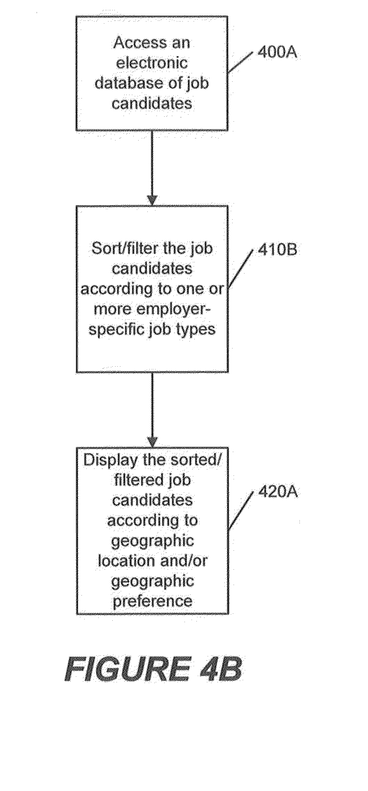

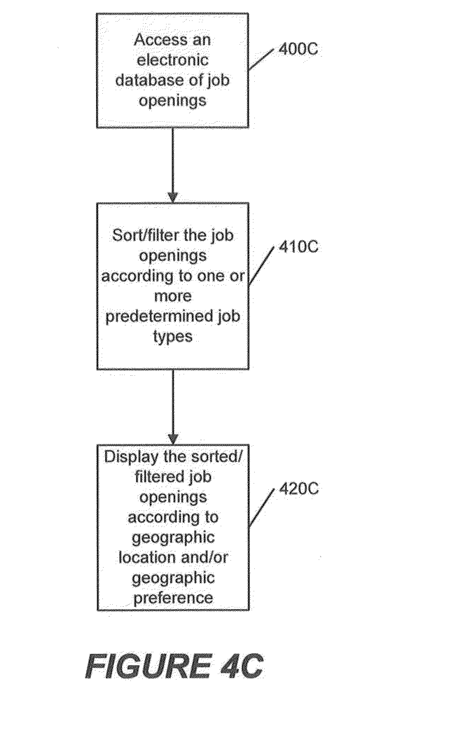

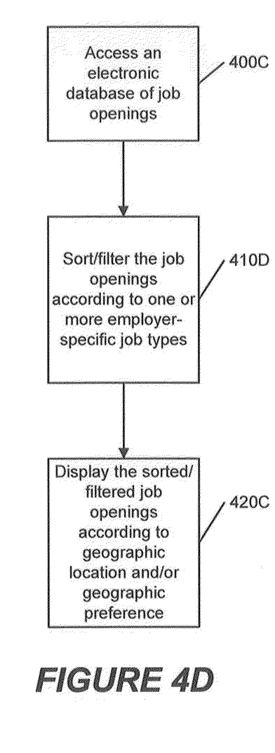

After matching job candidates (e.g., in FIGS. 2A-2C) and/or job openings (e.g., in FIGS. 1A-1C) to job types, the job candidates may be electronically displayed to employers, and/or the job openings may be electronically displayed to job candidates. In particular, referring now to FIGS. 4A-4D, flowcharts are provided illustrating operations of displaying (e.g., visualizing) job candidates (FIGS. 4A and 4B) and job openings (FIGS. 4C and 4D) based on job type, according to various embodiments of the inventive concepts.

Referring to FIG. 4A, operations of displaying job candidates based on job type may include accessing an electronic database including information/profiles corresponding to a plurality of job candidates (Block 400A). The operations may also include filtering (e.g., sorting) the job candidates according to one or more predetermined job types and/or one or more careers (Block 410A). For example, the job candidates may be filtered such that only job candidates corresponding to a machinist job type are included. Moreover, it will be understood that the predetermined job type(s) may be mapped to one or more job skills and/or job credentials in an electronic database, as described herein.

The operations may further include displaying the job candidates that remain after the filtering, according to the job candidates' current geographic locations and/or according to the geographic preferences of the job candidates (i.e., where they would prefer to work, which may be different from their current locations) (Block 420A). For example, the filtered job candidates may be displayed on a map on a user's (e.g., an employer's) electronic device. The map may be interactive such that levels of zoom (e.g., zoom levels ranging from the world, to a country, to a state, to a county, to a zip code, and to a specific street) may be adjusted, to change which of the filtered job candidates is displayed to the user. Moreover, the map may be interactive such that clicking/touching/highlighting a portion of the map displays information about one or more filtered job candidates. For example, additional (e.g., more detailed) information about an individual one of the filtered job candidates may be provided by clicking/touching/highlighting the individual filtered job candidate on the map.

The job candidates may be filtered in Block 410A using one or more standardized job types that are consistent across a plurality of employers. Additionally or alternatively, referring to FIG. 4B, the job candidates may be filtered using one or more employer-specific customized job types (Block 410B). Moreover, it will be understood that the employer-specific customized job type(s) may be mapped to one or more job skills and/or job credentials in an electronic database, as described herein.

Referring to FIG. 4C, operations of displaying job openings based on job type may include accessing an electronic database that includes discrete job openings (Block 400C). The operations may also include filtering (e.g., sorting) the job openings according to one or more predetermined job types (Block 410C). For example, the job openings may be filtered such that only job openings corresponding to a machinist job type are included. Moreover, it will be understood that the predetermined job type(s) may be mapped to one or more job skills and/or job credentials in an electronic database, as described herein.

The operations may further include displaying the job openings that remain after the filtering, according to geographic locations of the job openings (Block 420C). Additionally or alternatively, in some embodiments, only job openings that match a job candidate's current geographic location and/or geographic preference(s) (i.e., one or more places where the job candidate would prefer to work, which may be different from the job candidate's current location) may be displayed. The filtered job openings may be displayed on a map on a user's (e.g., a job candidate's) electronic device. The map may be interactive such that levels of zoom (e.g., zoom levels ranging from the world, to a country, to a state, to a county, to a zip code, and to a specific street) may be adjusted, to change which of the filtered job openings is displayed to the user. Moreover, the map may be interactive such that clicking/touching/highlighting a portion of the map displays information about one or more filtered job openings. For example, additional (e.g., more detailed) information about an individual one of the filtered job openings may be provided by clicking/touching/highlighting the individual filtered job opening on the map.

The job openings may be filtered in Block 410C using one or more standardized job types that are consistent across a plurality of employers. Additionally or alternatively, referring to FIG. 4D, the job openings may be filtered using one or more employer-specific customized job types (Block 410D). Moreover, it will be understood that the employer-specific customized job type(s) may be mapped to one or more job skills and/or job credentials in an electronic database, as described herein.

Accordingly, the operations of FIGS. 4A-4D may help employers and job candidates to visualize where precisely-matched available job candidates and available job openings, respectively, are located. The operations may also allow a user to click/touch/highlight a portion of an electronic map to obtain additional information about available job candidates/openings. The electronic maps that may be used with respect to the operations of FIGS. 4A-4D may be referred to as “heat maps.” Moreover, it will be understood that the job types in the operations of FIGS. 4A-4D may correspond to unique identifiers, as described herein. Also, it will be understood that the one or more of the job candidates in the operations of FIGS. 4A and 4B may have military experience/skills, as described herein.

E. Visual Comparison of Job Candidates

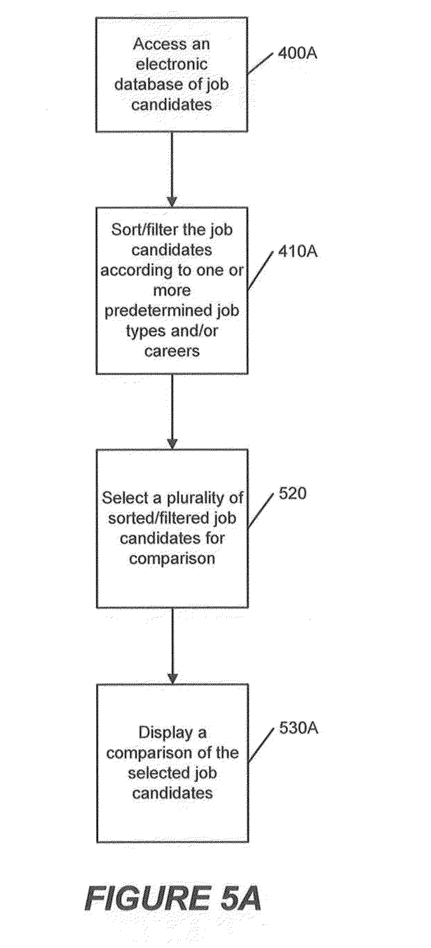

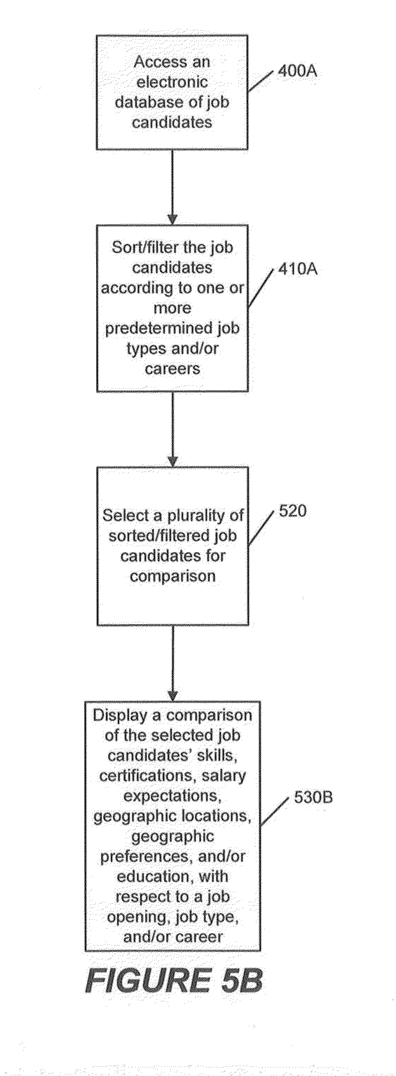

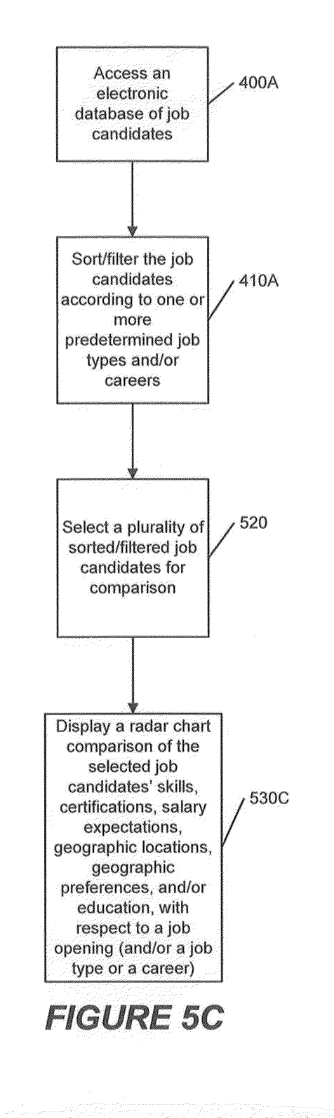

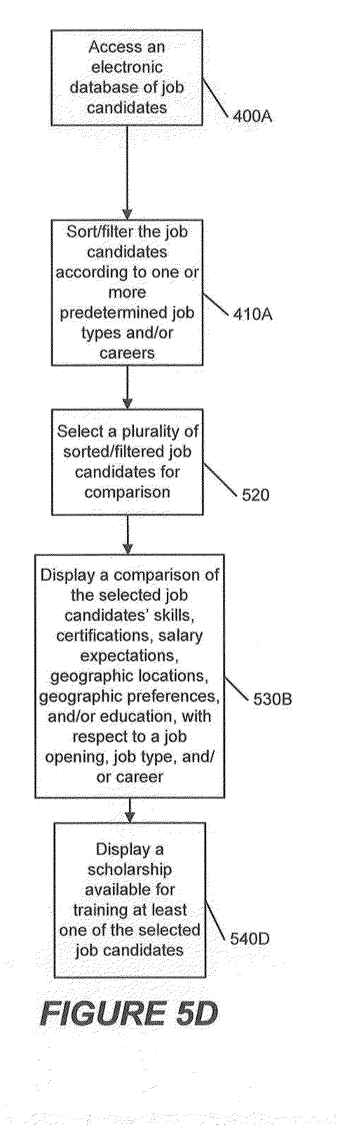

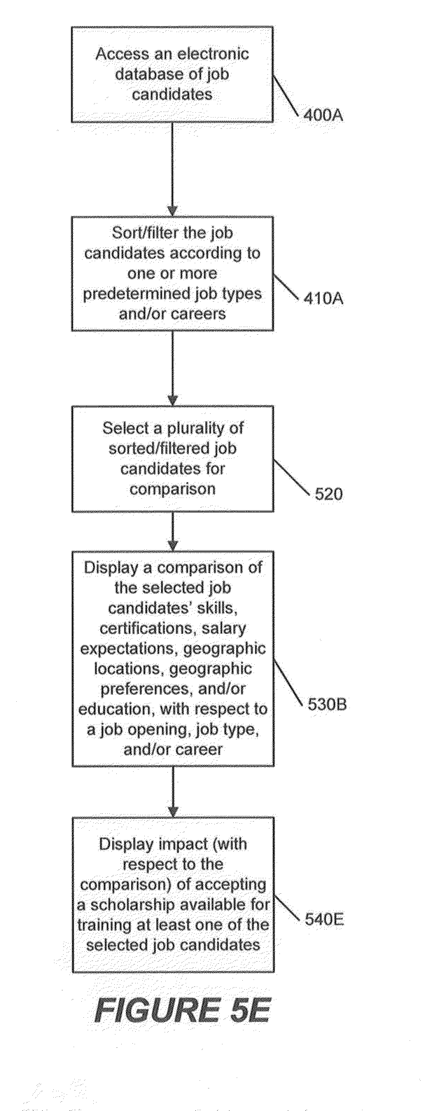

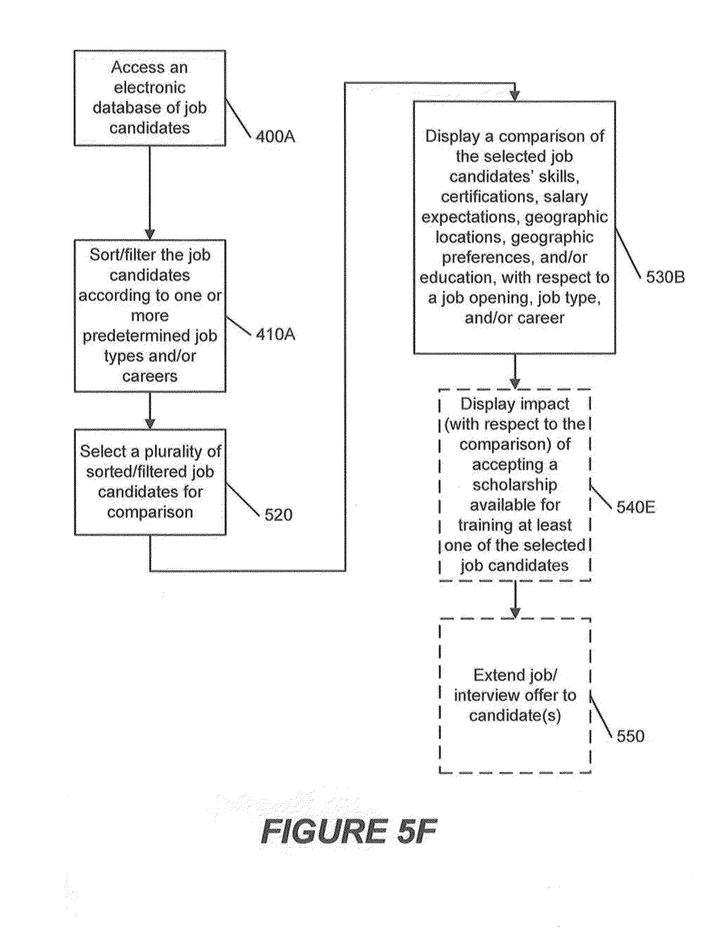

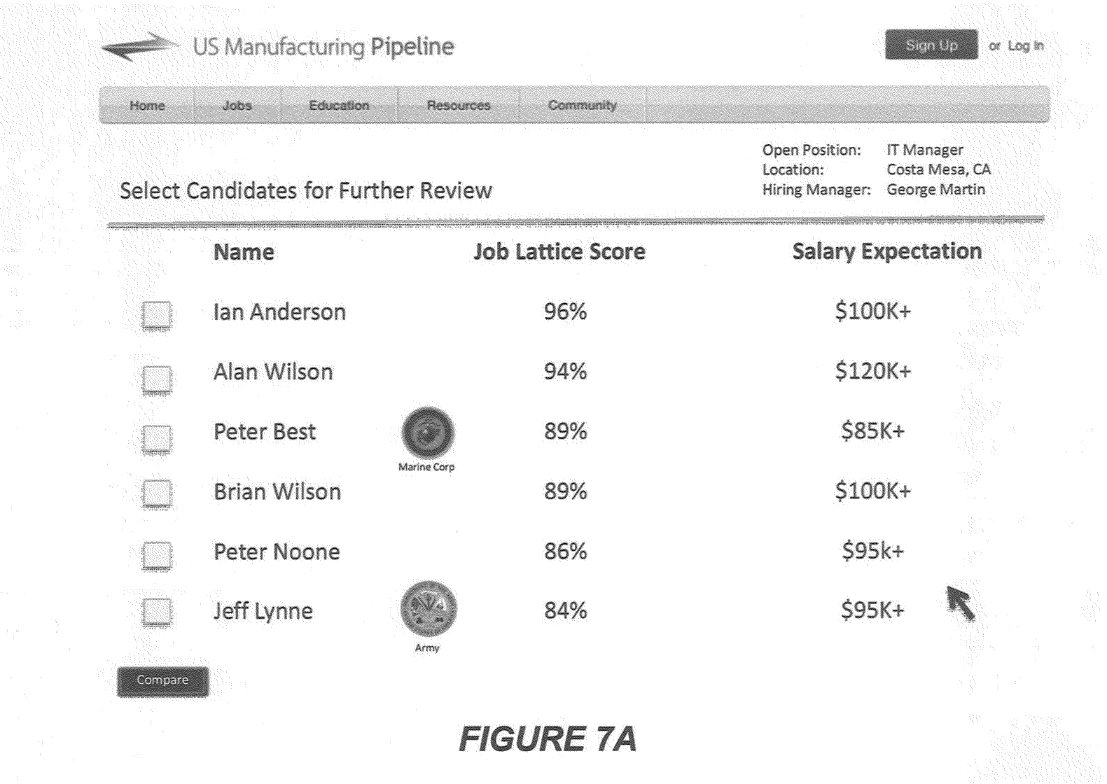

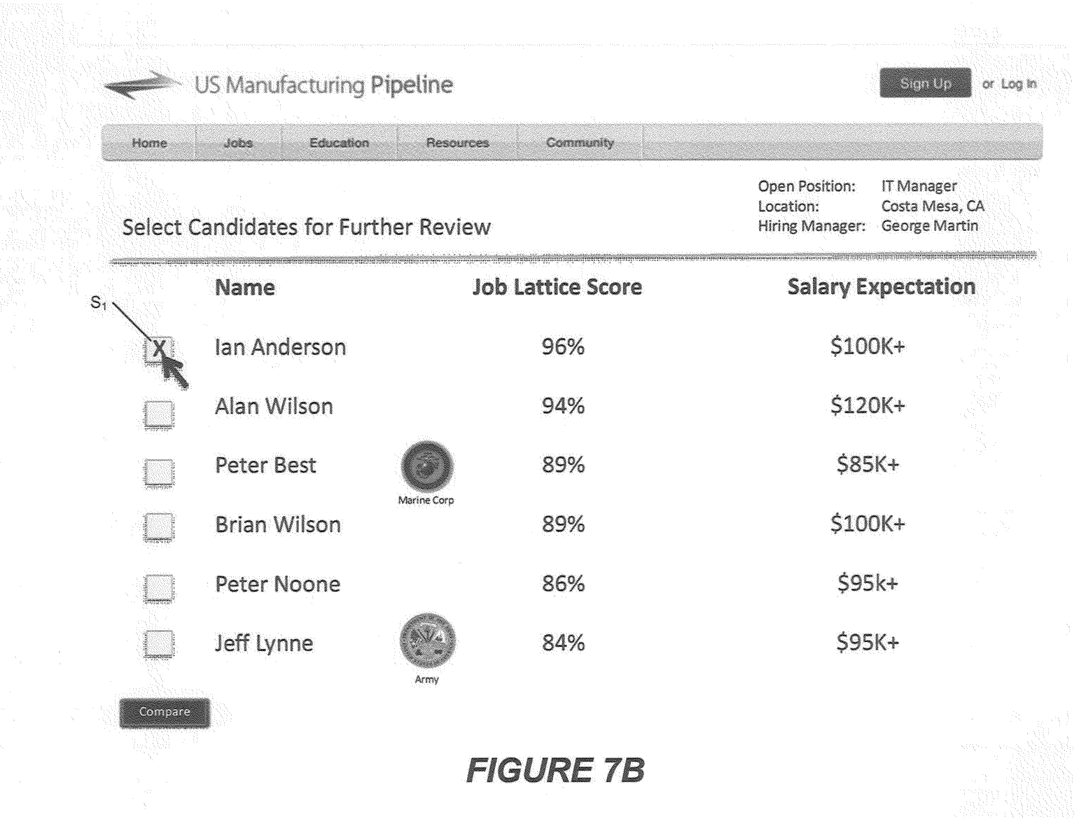

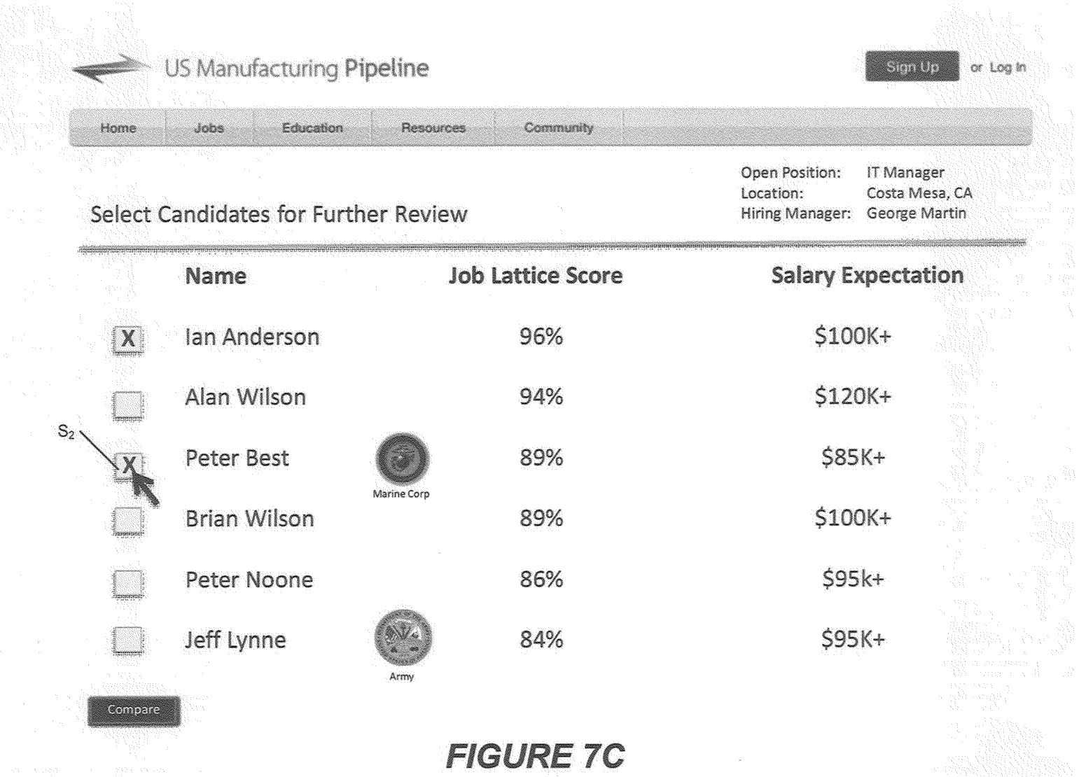

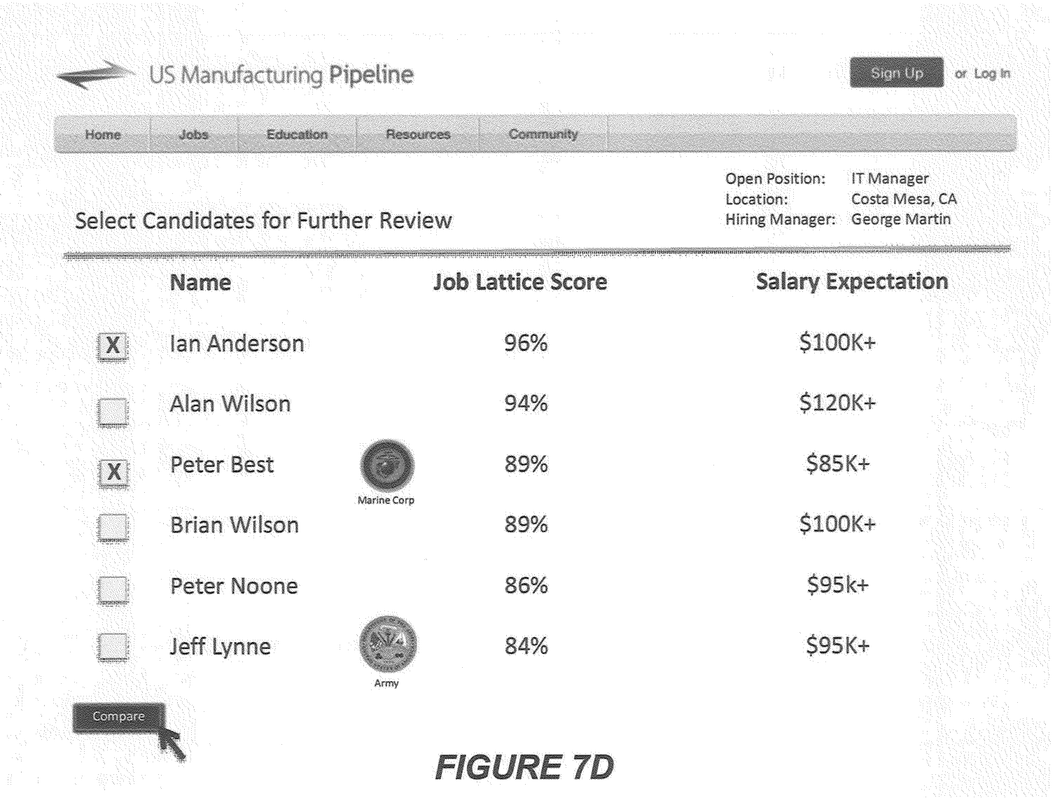

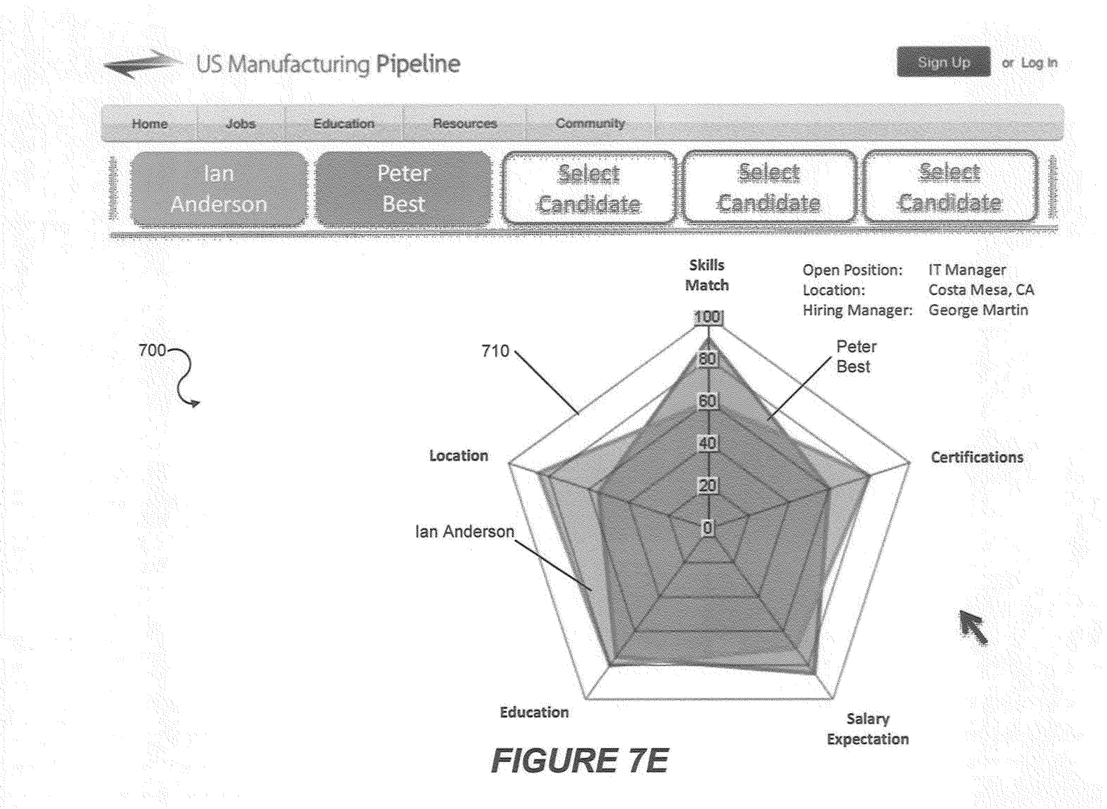

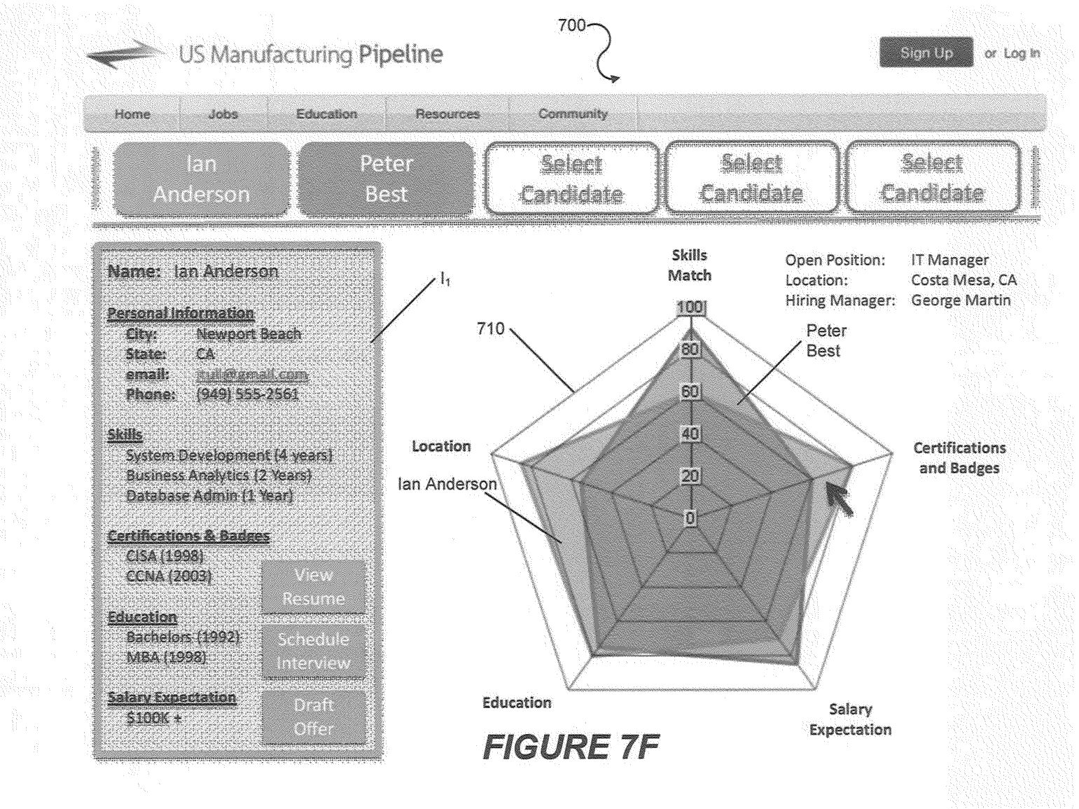

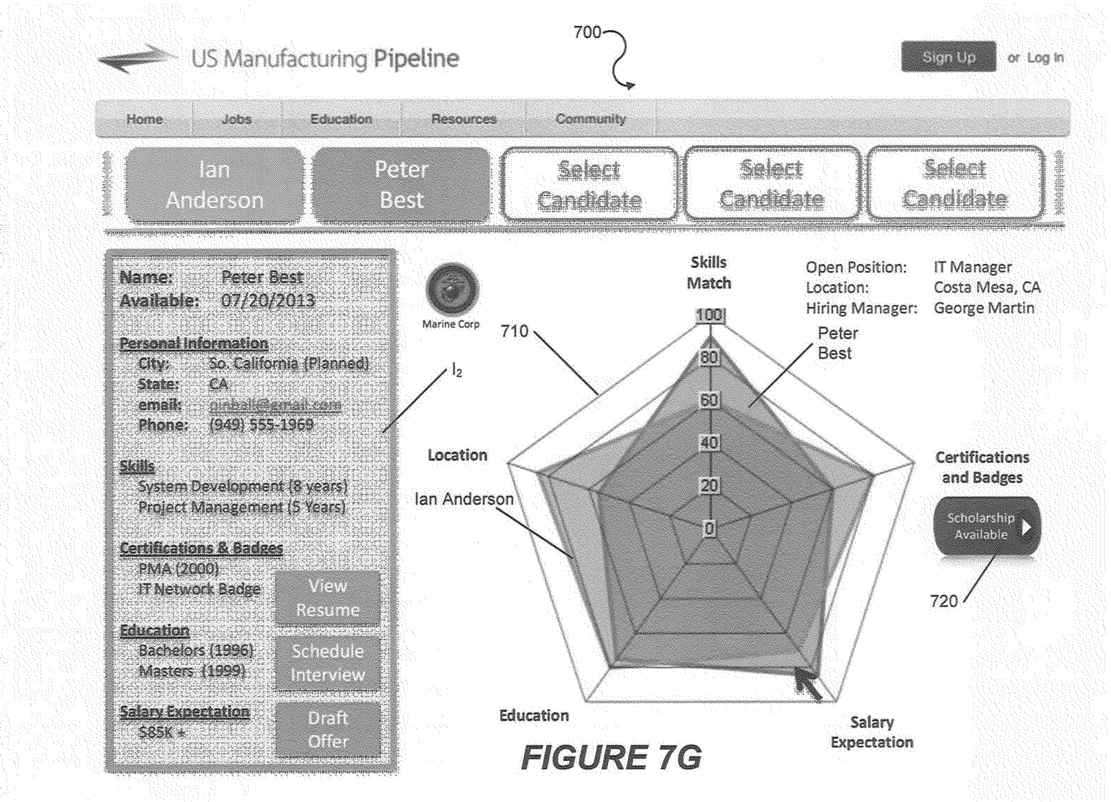

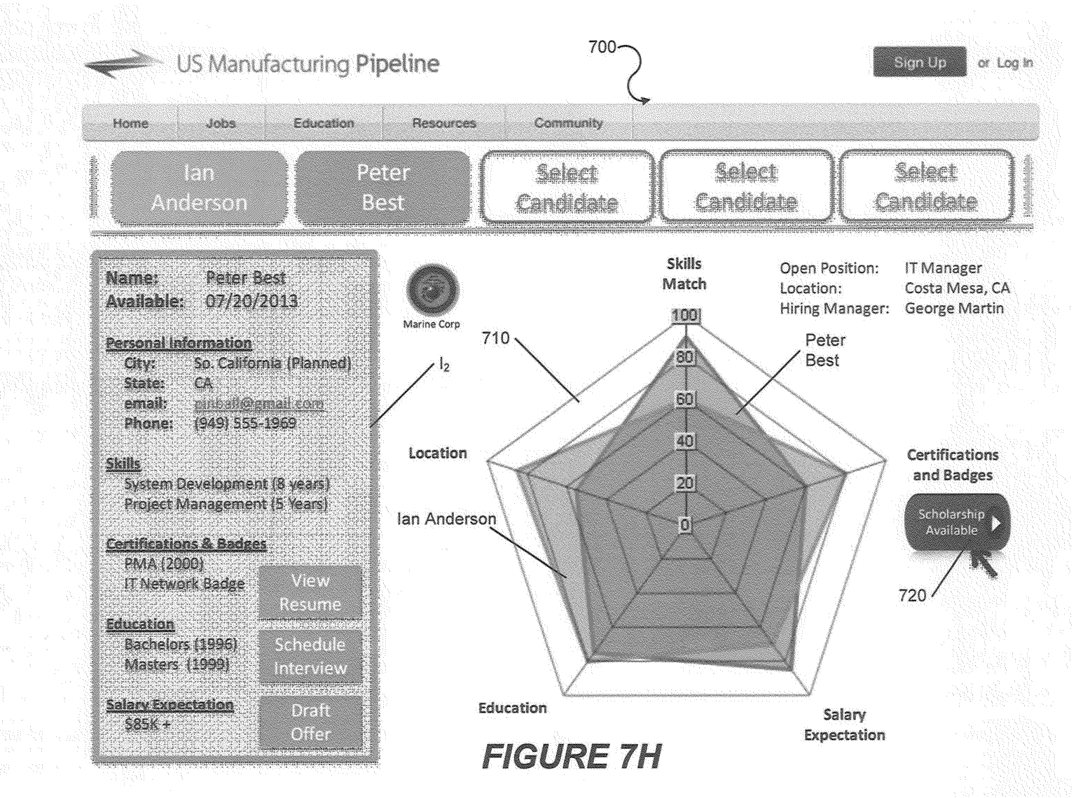

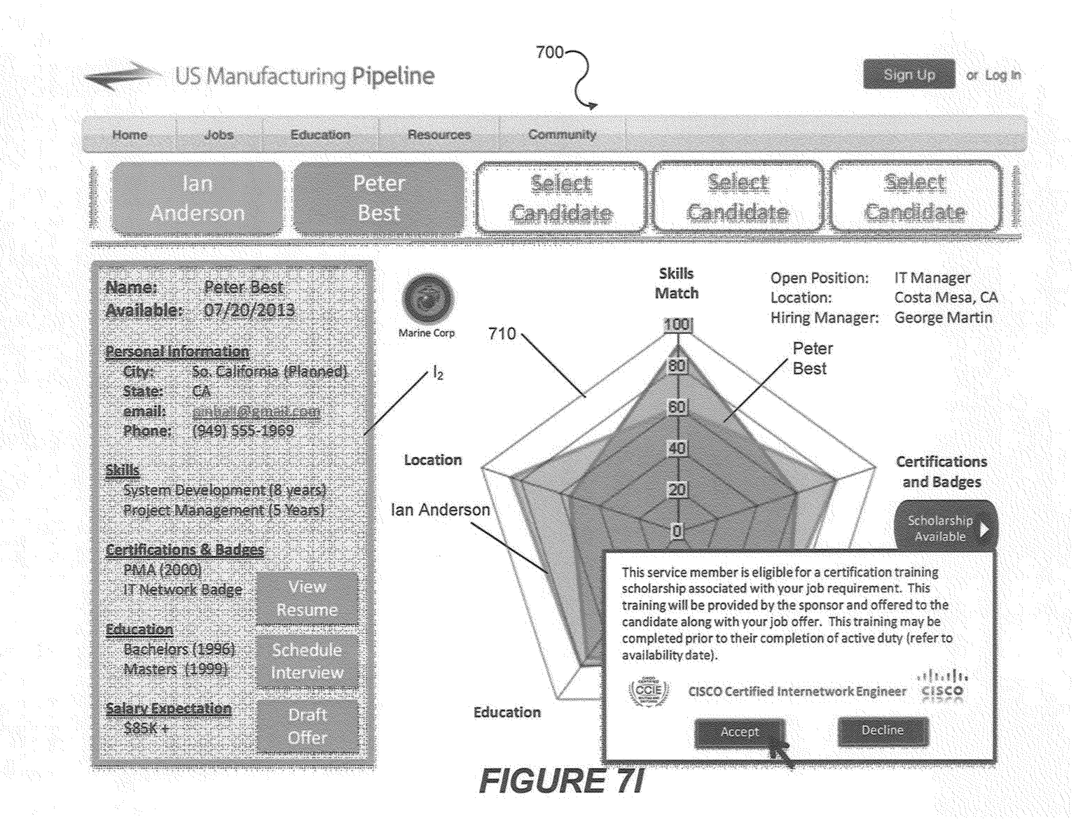

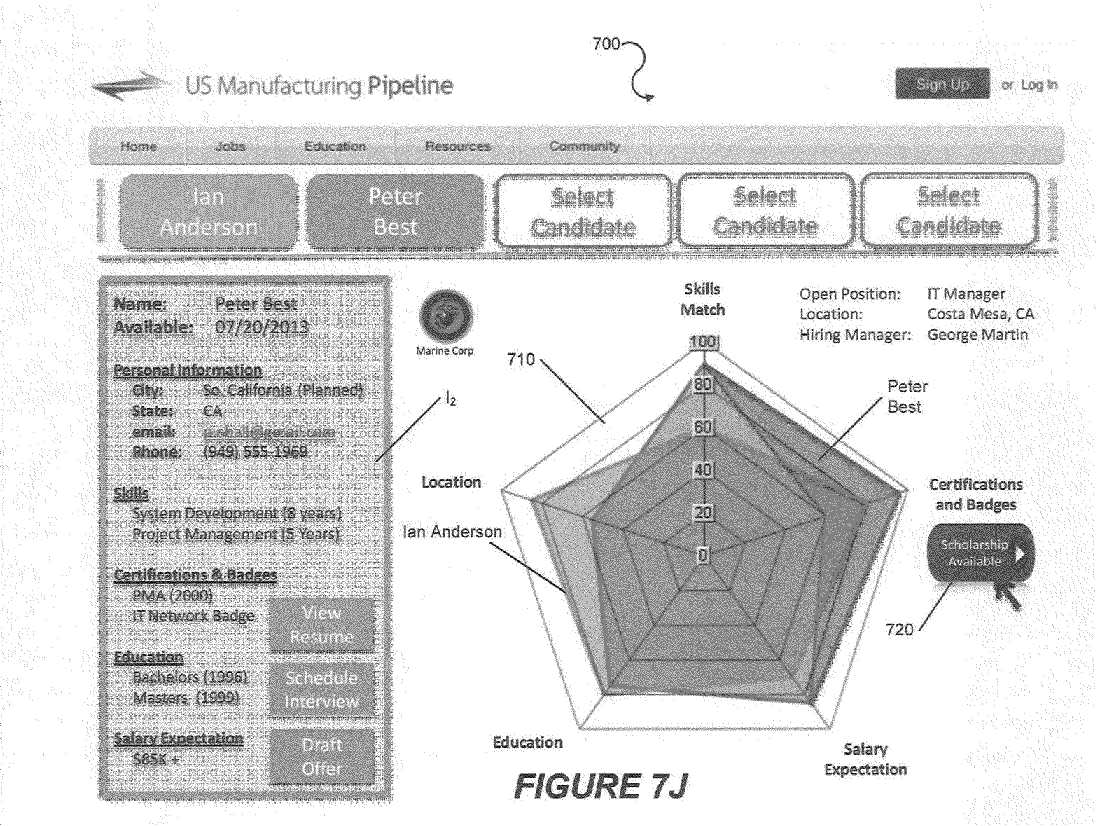

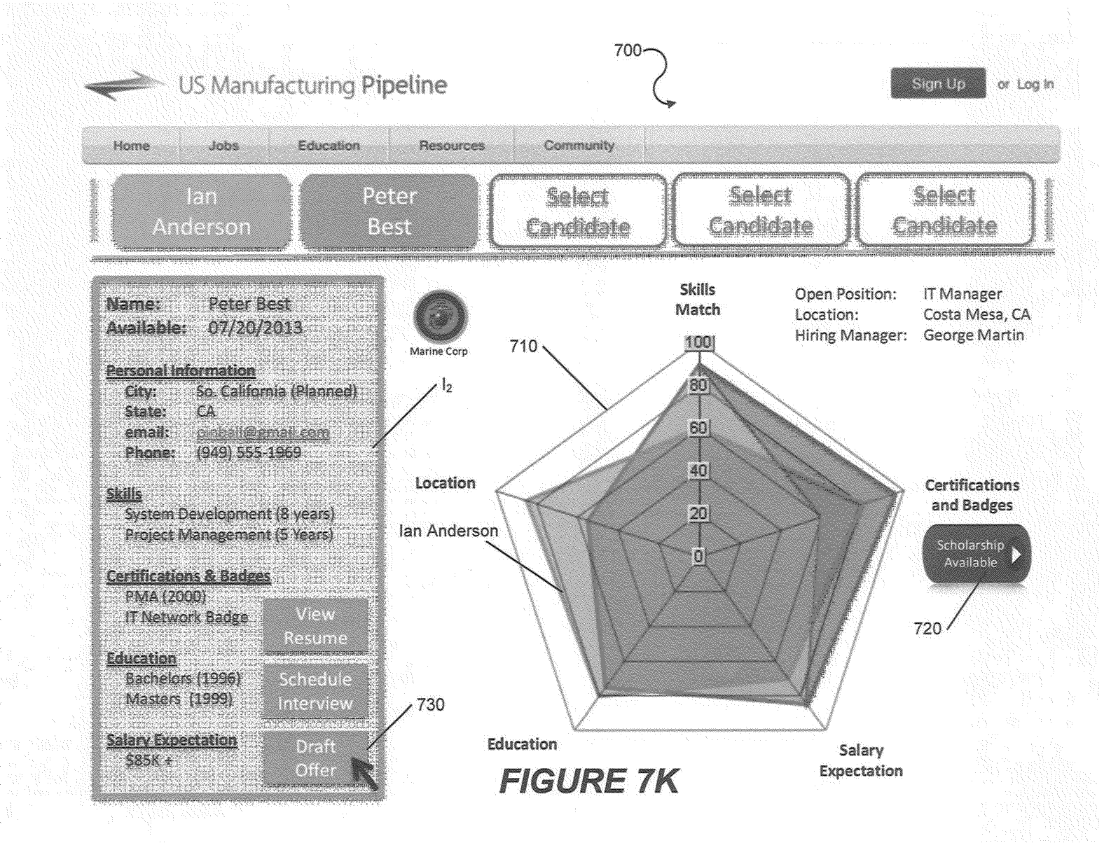

An employer or a recruiter may benefit from a visual comparison of a plurality of job candidates. In particular, referring now to FIGS. 5A-5F, flowcharts are provided illustrating operations of visually comparing job candidates, according to various embodiments of the inventive concepts. Additionally, FIGS. 7A-7K illustrate screenshots of an electronic device performing various operations illustrated in the flowcharts of FIGS. 5A-5F.

Referring to FIG. 5A, after performing the operations of Blocks 400A and 410A of FIG. 4A, the operations may further include selecting for comparison a plurality of the job candidates that remain after the filtering operation in Block 410A (Block 520). For example, an employer or a recruiter may use a Graphical User Interface (GUI) of an electronic device to make the selections in Block 520. As an example, FIGS. 7A-7D illustrate screenshots of using a GUI to make the selections in Block 520. The filtered job candidates (e.g., Ian Anderson, Alan Wilson, Peter Best, Brian Wilson, Peter Noone, and Jeff Lynne) that are available for selection may be listed/ranked along with indications of salary expectation, scores of how well the job candidates match the predetermined job type(s) and/or a particular job opening, and/or indications of military experience/skills. For example, first and second selections S₁ and S₂ are illustrated in FIGS. 7B and 7C, respectively. In response to the selections in Block 520, a visual comparison of the selected job candidates may be displayed (e.g., via the GUI) (Block 530A).

Referring to FIG. 5B, displaying the visual comparison of Block 530A may include displaying a visual comparison of the selected job candidates' job skills, certifications, salary expectations, current geographic locations, geographic preferences, and/or education levels, with respect to a job opening (and/or with respect to a job type or a career) (Block 530B). Referring to FIG. 5C, the visual comparison of Block 530B may be a radar chart comparison (Block 530C). As an example, FIG. 7E illustrates a GUI screenshot 700 of a radar chart comparison 710 between two job candidates (e.g., Ian Anderson and Peter Best). Moreover, as illustrated in FIGS. 5C and 7E, the selected job candidates' job skills, certifications, salary expectations, current geographic locations, and/or education levels may be mapped with respect to how well (e.g., in terms of a percentage) they match the skills, certifications, salary expectations, current geographic locations, and/or education levels preferred or required for a job opening. Each of these categories may have its own axis/region of the chart 710, and the job candidates may be indicated on the chart 710 in a partially-overlapping manner. Moreover, the job candidates' geographic preferences may additionally or alternatively be indicated on the chart 710.

As an example of a radar chart comparison, FIG. 7E illustrates that the chart 710 may visually indicate that a first job candidate is a 90% skills match and a 60% certifications match with a job opening, whereas a second job candidate is a 60% skills match and an 80% certifications match. As the visual comparison may be a radar chart comparison, each candidate may be represented on the radar chart 710 by a polygon that extends different lengths in different directions that correspond to respective categories. Moreover, polygons of respective job candidates may partially overlap each other on the radar chart 710. Additionally, FIGS. 7F and 7G illustrate that a user may use the GUI to access additional information I (e.g., additional personal and/or educational information) regarding the job candidates. For example, FIGS. 7F and 7G illustrate first and second additional information I₁, I₂ for first and second job candidates, respectively.

Referring to FIG. 5D, after/while the visual comparison in Block 530B is displayed, an indication may be displayed of one or more scholarships that are available to train one or more of the selected job candidates (Block 540D). As illustrated in FIGS. 7G and 7H, the indication of the available scholarship(s) 720 may be displayed in the GUI adjacent the visual comparison (e.g., adjacent the certifications category). Additionally or alternatively, FIGS. 5E, 7I, and 7J illustrate that the impact (with respect to the visual comparison in Block 530B) of accepting a scholarship available for training one or more of the selected job candidates may be displayed (Block 540E). For example, FIG. 7J illustrates that the visual comparison of the chart 710 may adjust to indicate improvements in the certifications matches of one of the selected job candidates (e.g., Peter Best) that would result if the selected job candidate received the training. It will be understood, however, that the impact of accepting the scholarship may be displayed with respect to a plurality of the selected job candidates or with respect to only one of the selected job candidates.

Referring to FIGS. 5F and 7K, after displaying the visual comparison in Block 530B (and after optionally displaying the impact of accepting a training scholarship in Block 540E), an employer or a recruiter may optionally choose to provide/extend (e.g., to transmit via an electronic message) an interview offer (or even a job offer) to one or more of the selected job candidates (Block 550). For example, FIG. 7K illustrates that the employer or recruiter may use the GUI to draft 730 an offer.

F. Operations Performed by/for Job Candidates

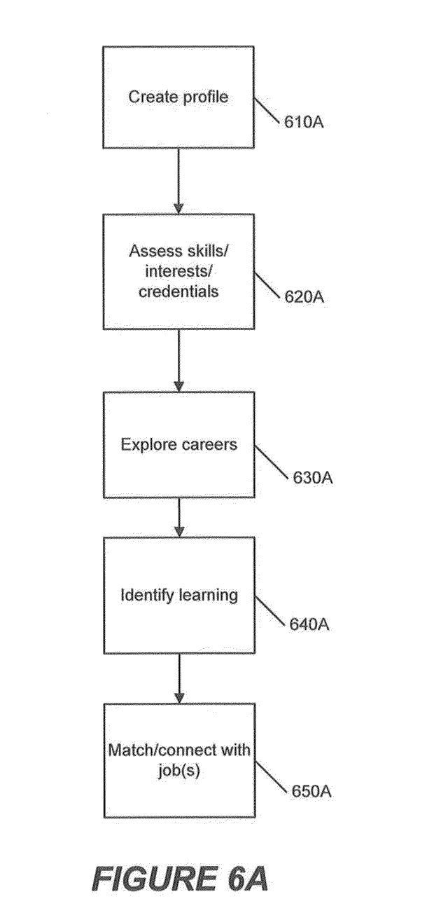

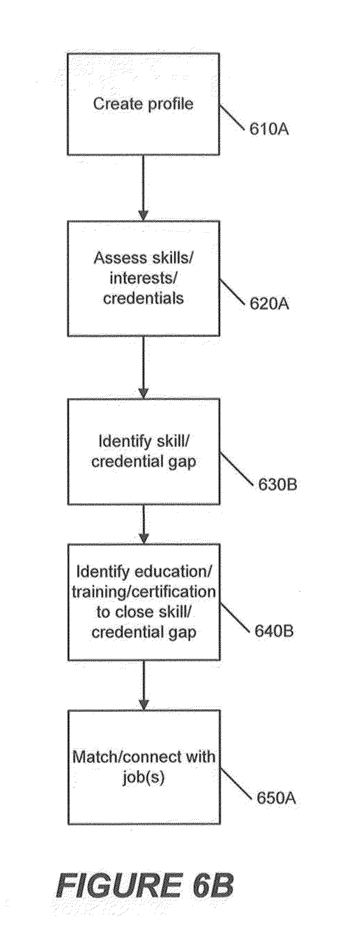

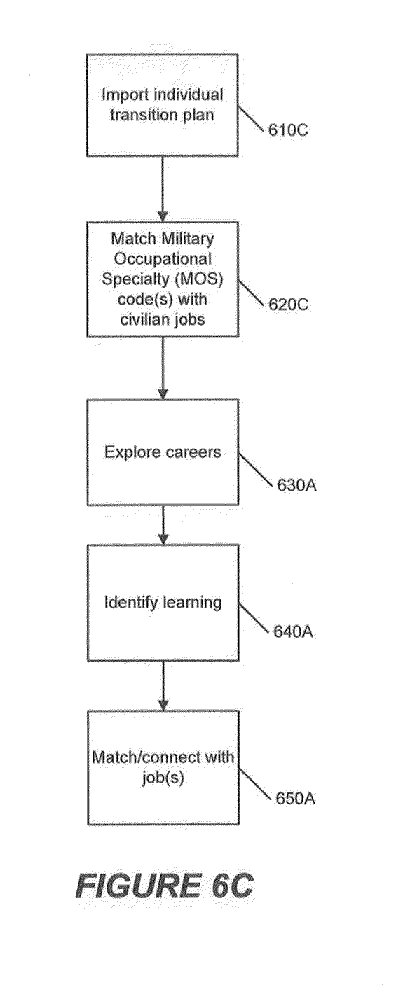

Referring now to FIGS. 6A-6C, flowcharts are provided illustrating operations of electronic employment support for a job candidate, according to various embodiments of the inventive concepts. Referring to FIG. 6A, the operations may include creating an electronic job candidate profile for the job candidate (Block 610A). For example, the job candidate may use a GUI of an electronic device to access a website and/or an electronic application (e.g., a mobile application or a software application) to create the job candidate profile. The job candidate may then receive an electronic assessment of his/her job skills, job credentials, and/or job interests (Block 620A). For example, the website or electronic application may assess the job candidate and provide the assessment to the job candidate. Moreover, it will be understood that the job skills and/or job credentials may be mapped to one or more predetermined job types in an electronic database, as described herein.

After receiving the electronic assessment in Block 620A, the operations may optionally include receiving electronic information regarding job opportunities (Block 630A). For example the job candidate may receive information regarding job opportunities in a particular state, region, and/or industry. Moreover, the job candidate may view day-in-the-life videos regarding different careers. Additionally or alternatively, the job candidate may receive information regarding career counselors and/or career mentors. If the job candidate has military experience, then the information may regard transition (from the military to civilian jobs) support counselors/mentors. Accordingly, the operations of Block 630A may allow the job candidate to explore one or more careers.

The job candidate may also optionally receive electronic information regarding educational, training, and/or certification opportunities (Block 640A). The information may optionally include information regarding internships and/or apprenticeships.

After performing one or more of the operations of Blocks 620A-640A, the job candidate may receive one or more electronic matches with one or more job openings (Block 650A). It will be understood that the job candidate may be matched with the job opening(s) by using one or more predetermined job types, as described herein.

Referring to FIG. 6B, the operations of Block 630A may include identifying a skill/credential gap of the job candidate with respect to one or more careers/job openings (Block 630B). For example, the job candidate may receive an indication of a job skills and/or job credentials threshold that he/she fails to meet. In some embodiments, operations of matching (e.g., in Blocks 210A or 210B of FIGS. 2A-2C) the job candidate with one or more careers/job openings/predetermined job types may include identifying a skill gap and/or a credential gap of the job candidate with respect to one or more careers/job openings/predetermined job types.

Moreover, the operations of Block 640A (and of Blocks 210A or 210B) may include identifying education, training, and/or certification opportunities to close the skill/credential gap (Block 640B). For example, the job candidate may receive information regarding educational, training, and/or certification opportunities that will help the job candidate to meet the skills and/or job credentials threshold.

Referring to FIG. 6C, the operations in Block 610A (of FIGS. 6A and 6B) of creating an electronic job candidate profile may include electronically importing a military individual transition plan of the job candidate (Block 610C). For example, the job candidate may use a GUI of an electronic device to access a website and/or an electronic application (e.g., a mobile application or a software application) to import the individual transition plan to his/her job candidate profile. Moreover, the electronic assessment (in Block 620A) of the job candidate's job skills, job credentials, and/or job interests may include one or more matches between civilian careers and one or more Military Occupational Specialty (MOS) codes of the job candidate (Block 620C). For example, the job candidate's electronic job candidate profile may include his/her MOS code(s), and an electronic database may be used to match the MOS code(s) with examples of civilian careers (or with actual available job openings). It will be understood that such skills matching may be performed using various embodiments of the skills matching operations described herein.

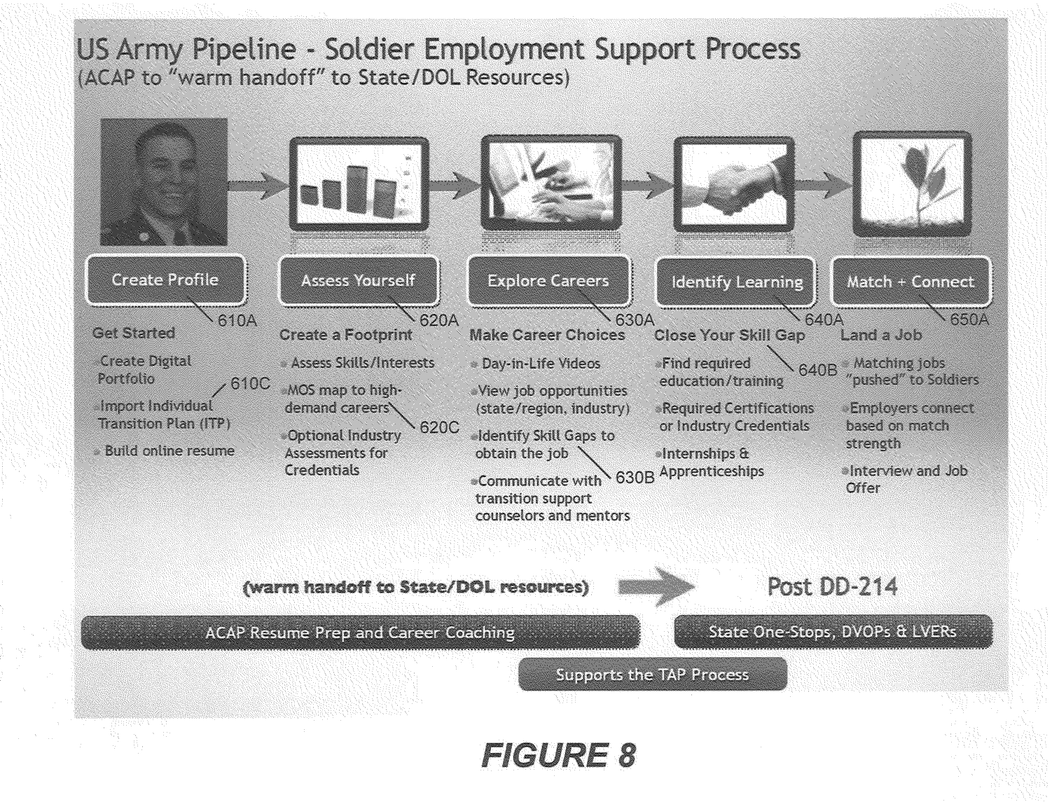

Moreover, various operations of FIGS. 6A-6C are further illustrated in FIG. 8, which illustrates an employment support process for a soldier/retired soldier.

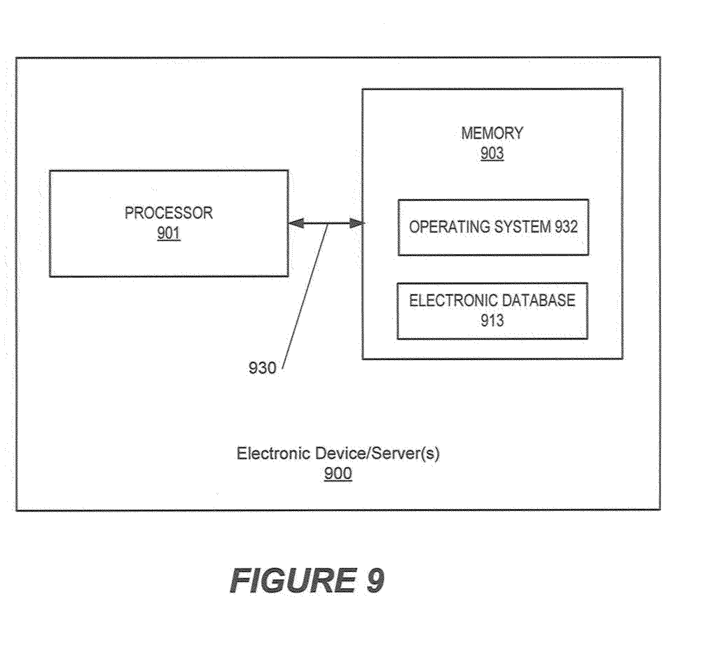

FIG. 9 is a block diagram that illustrates details of an example processor and memory that may be used in accordance with embodiments of the present inventive concepts. In particular, FIG. 9 illustrates an example processor 901 and memory 903 of an electronic device or a server/group of servers 900 (e.g., an electronic device or server(s) as described regarding flowcharts herein, or other/additional electronic device/server(s)), according to some embodiments of the present inventive concepts. For example, in some embodiments, a job candidate may use an electronic device 900 to perform the operations illustrated in FIG. 8, and an employer may use another electronic device 900 to perform the operations illustrated in FIGS. 7A-7K. The processor 901 communicates with the memory 903 via an address/data bus 930. The processor 901 may be, for example, a commercially available or custom microprocessor. Moreover, it will be understood that the processor may include multiple processors. The memory 903 is representative of the overall hierarchy of memory devices containing the software and data used to implement various functions of an electronic device/server(s) 900 as described herein. The memory 903 may include, but is not limited to, the following types of devices: cache, ROM, PROM, EPROM, EEPROM, flash, SRAM, and DRAM.

As shown in FIG. 9, the memory 903 may hold various categories of software and data, such as an operating system 932 and/or an electronic database 913. The operating system 932 controls operations of the electronic device/server(s) 900. For example, the operating system 932 may coordinate execution of various programs (e.g., the electronic database 913) by the processor 901. The electronic device/server(s) 900 may be used to perform any of the operations of FIGS. 1A-8. The electronic device 900 may include a display and a GUI as described herein with respect to the operations of FIGS. 1A-8.

In the specification, various embodiments of the inventive concepts have been disclosed and, although specific terms are employed, they are used in a generic and descriptive sense only and not for purposes of limitation. Those skilled in the art will readily appreciate that many modifications are possible for the disclosed embodiments without materially departing from the teachings and advantages of the inventive concepts. The inventive concepts are defined by the following claims, with equivalents of the claims to be included therein.

1-7. (canceled)

8. A method of matching a job candidate with a job type, the method comprising:
identifying one or more job skills and/or job credentials of the job candidate; and
matching the job candidate with one or more predetermined job types by matching the one or more job skills and/or job credentials of the job candidate with one or more skills and/or credentials corresponding to the one or more predetermined job types, using an electronic database.

9. The method of claim 8, wherein:
the electronic database comprises a military-to-civilian electronic database that matches military skills, codes, and/or credentials with civilian job skills and/or civilian job credentials; and
matching the one or more job skills and/or job credentials of the job candidate with the one or more skills and/or credentials corresponding to the one or more predetermined job types comprises:
matching one or more military skills, codes, and/or credentials of the job candidate with the one or more civilian job skills and/or civilian job credentials corresponding to the one or more predetermined job types, using the military-to-civilian electronic database.

10. The method of claim 8, further comprising:
matching the job candidate with one or more job openings, using the one or more predetermined job types that are matched with the job candidate.

11. The method of claim 8, wherein:
the one or more job skills and/or job credentials of the job candidate comprise an indication of years of experience of the job candidate; and
matching the one or more job skills and/or job credentials of the job candidate with the one or more skills and/or credentials corresponding to the one or more predetermined job types comprises:
matching the one or more job skills and/or job credentials of the job candidate with the one or more skills and/or credentials corresponding to the one or more predetermined job types, using the indication of years of experience of the job candidate.

12. The method of claim 8, wherein matching the job candidate comprises matching the job candidate with one or more careers and/or with the one or more predetermined job types, by matching the one or more job skills and/or job credentials of the job candidate with one or more skills and/or credentials corresponding to the one or more careers and/or with the one or more skills and/or credentials corresponding to the one or more predetermined job types, using the electronic database.

13-39. (canceled)

40. A method of employment support for a job candidate, the method comprising:
creating an electronic job candidate profile for the job candidate;
receiving an electronic assessment of job skills and/or job credentials of the job candidate, wherein the job skills and/or job credentials are mapped to one or more predetermined job types in an electronic database; and
receiving one or more electronic matches of the job candidate with one or more job openings, using the one or more predetermined job types.

41. The method of claim 40, further comprising:
receiving electronic information regarding job opportunities, after receiving the electronic assessment; and
receiving electronic information regarding educational, training, and/or certification opportunities, after receiving the electronic information regarding job opportunities.

42. The method of claim 41, wherein receiving the electronic information regarding job opportunities comprises receiving an indication of a job skills and/or job credentials threshold that the job candidate fails to meet.

43. The method of claim 42, wherein receiving the electronic information regarding educational, training, and/or certification opportunities comprises receiving information regarding educational, training, and/or certification opportunities that will help the job candidate to meet the job skills and/or job credentials threshold.

44. The method of claim 40, wherein creating the electronic job candidate profile comprises electronically importing a military individual transition plan of the job candidate.

45. The method of claim 44, wherein receiving the electronic assessment comprises receiving one or more matches between civilian careers and one or more Military Occupational Specialty (MOS) codes of the job candidate.

46. An electronic device, configured to perform the method of claim 8.

47. A server, configured to perform the method of claim 8.

48. A system, configured to perform the method of claim 8.

49. An electronic device, configured to perform the method of claim 40.

50. A server, configured to perform the method of claim 40.

51. A system, configured to perform the method of claim 40.

52. The method of claim 12, wherein matching the job candidate with the one or more careers and/or with the one or more predetermined job types comprises identifying a skill gap and/or a credential gap of the job candidate with respect to the one or more careers and/or with respect to the one or more predetermined job types.

53. The method of claim 52, further comprising identifying education, training, and/or certification opportunities to close the skill gap and/or the credential gap.
